(19) United States
(12) Patent Application Publication
(10) Pub. No.: US 2015/0379255 A1
(43) Pub. Date: Dec. 31, 2015

(54) SYSTEMS AND METHODS FOR GRANTING ACCESS TO A COMPUTING DEVICE USING A WEARABLE DEVICE

(71) Applicants: ANAND KONANUR, Sunnyvale, CA (US); FARID ADRANGI, Lake Oswego, OR (US); ULUN KARACAOGLU, San Diego, CA (US)

(72) Inventors: ANAND KONANUR, Sunnyvale, CA (US); FARID ADRANGI, Lake Oswego, OR (US); ULUN KARACAOGLU, San Diego, CA (US)

(21) Appl. No.: 14/314,568

(22) Filed: Jun. 25, 2014

(51) Int. Cl. G06F 21/34; G06F 21/35; G06F 21/32

(52) U.S. Cl. CPC G06F 21/34; G06F 21/32; G06F 21/35

(57) ABSTRACT

Certain embodiments herein relate to authenticating access to a computing device by a user. Such authentication can be performed by processing information received from a wearable device transmitting a signal, including access credentials data, through the user's body to a computing device in electrical contact with the computing device. The computing device can process the received signal to extract the access credentials data. Upon validating the extracted access credentials data, the computing device can grant a user access to the computing device. In some embodiments, the computing device can additionally receive biometric data acquired from the user by the computing device. In such embodiments, the computing device can grant the user access to the computing device if the received access credentials data and the received biometric data are authenticated.

### TECHNICAL FIELD

Embodiments of the present disclosure relate generally to data communications between a computing device and a wearable device by transmitting and receiving signals through a user's body and, in particular, to granting user access to a computing device by authentication of a wearable device.

### BACKGROUND

Users of computing devices are oftentimes required to authenticate or present access credentials before they may utilize software applications installed on the computing devices. Some existing authentication techniques leverage short range wireless communications to implement touch to login technologies in which a token device is placed in contact with a token device reader to authenticate a user's credentials to a computing device. However, despite the pervasiveness of token devices, such as Near Field Communications (“NFC”) equipped mobile phones, users have been hesitant to adopt such technologies because it can involve what users perceive to be too many steps (e.g., retrieve an object out of the user's pocket and present it to a reader). Additionally, when touch to login technologies are combined with biometrics to create a two factor authentication system (or revocable biometric system), the user has to perform even more steps for authentication. For example, the user has to retrieve the token device from the user's person, present it to the token device reader and then present the biometric data requested by the computing system (e.g., a fingerprint).

### BRIEF DESCRIPTION OF THE FIGURES

The detailed description is set forth with reference to the accompanying figures. In the figures, the left-most digit(s) of a reference number identifies the figure in which the reference number first appears.

FIG. 1 is a schematic depiction of an embodiment of an authentication system according to the present disclosure.

FIG. 2 is a schematic depiction of an embodiment of an authentication system showing the interaction between a computing device and a wearable device according to the present disclosure, according to the present disclosure.

FIG. 3 is a schematic depiction of an embodiment of a data structure including access credentials data according to the present disclosure.

FIG. 4(A) is a schematic depiction showing a first orthogonal view of an embodiment of a wearable device according to the present disclosure.

FIG. 4(B) is a schematic depiction showing a second orthogonal view of the embodiment of a wearable device shown in FIG. 4(A).

FIG. 4(C) is a schematic depiction showing a third orthogonal view of the embodiment of a wearable device shown in FIG. 4(A)

FIG. 5 is a flow diagram illustrating an embodiment of a process for authentication access to an operating system by a user according to the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Certain embodiments herein relate to, among other things, authenticating a user's access credentials data to grant the user access to a computing device. In some embodiments, at least a portion of the user's access credentials data can be received by the computing device from a wearable device worn by a user and configured to send access credentials data to the computing device. In some such embodiments, the access credentials data can be sent by the wearable device to the computing device through at least a portion of the user's body. As used herein, body can refer to the dermis, epidermis (e.g., skin tissue), hair, muscular tissue, other conductive portions of an animal body or any combination thereof. In some embodiments, at least a portion of the user's access credentials data can be received by the computing device from biometric readers configured to acquire biometric data from the user. In further embodiments, at least a portion of the user's access credentials can be received by the computing device from a wearable device and from one or more biometric readers (e.g., two-part authentication). In some such embodiments, the authentication system can quickly and efficiently validate a user's access credentials data.

In some embodiments, authentication of a user's access credentials data can grant the user access to the computing device. Access credentials data can include, but is not limited to, an authentication token (uniquely identifying a wearable device), a login ID, a login password, biometric data or any combination of one or more thereof. Biometric data can include, but is not limited to, fingerprint data corresponding to one or more of the user's fingerprints or portions thereof, retinal data corresponding to one or more of the user's retina or portions thereof, facial image data corresponding to the user's face or a portion thereof, voice data corresponding to the user's voice or any combination thereof. Granting access to the computing device can include sending instructions to the basic input/output system (“BIOS”) of the computing device to boot an operating system (“OS”) installed on storage associated with the computing device and/or logging the user into the operating system to grant the user access to user applications installed on memory associated with the computing device. In some embodiments, access credentials data received from a wearable device and, optionally, a biometric reader, can include a portion of user access credentials data requested by the BIOS (e.g. to boot the operating system) and/or operating system (to grant the user access to applications stored on associated memory). In some such embodiments, the computing device can determine, based at least in part on the portion of the received access credentials data, the remaining user access credentials data from memory associated with the computing device and transmit the remaining user access credentials data and the received portion of the user access credentials data to the BIOS and/or operating system to grant the user access to the computing device, as described below.

In some embodiments, granting access to a computing device can include granting a user physical access to a structure integrated with the computing device. In some such embodiments, the computing device can facilitate physical access to the structure by unlocking a locked access way into the structure. For example, in embodiments in which the computing device is integrated with a building (e.g., a component of a building security system) or an automobile, granting access to a structure can include sending an instruction to the computing device to unlock a locked door associated with the building or other enclosure (e.g., an automobile) to allow a user to open the door. In some embodiments, granting access to a computing device can include granting access to an application accessible to the computing device. For example, granting access to the computing device can include granting a user access privileges to use the computing device to execute preselected applications accessible thereto. For example, granting access to the computing device can include granting the user the ability to launch a web browser and/or to authenticate the user's access to a website served from an external computing device.

In some embodiments, at least a portion of the user's access credentials data can be received by the computing device from a wearable device worn by the user and in electrical contact with the user's body. In some such embodiments, the computing device is configured to generate a first electrical signal and transmit the first electrical signal to the wearable device, which may be through a first portion of the user's body that is in electrical contact with the computing device. For clarity, as used hereinafter and in the claims, “signal” implicitly refers to “electrical signal,” unless explicitly distinguished otherwise. The wearable device can be configured to receive the first signal from the user's body and extract power from the first signal to power at least a portions of the wearable device. The wearable device can also be configured to generate, based at least in part on the first signal, a second signal including access credentials data that can be received by the computing device through the user's body. The computing device can receive the second signal from a second portion of the user's body (distinct from or the same as the first portion) in electrical contact with the computing device and extract the access credentials data from the received second signal. The computing device can authenticate the received access credentials data. Authenticating the received access credentials data can include, but is not limited to, determining if the received data matches access credentials data stored on the computing device or implementing other, well-known methods to determine if the received access credentials data is acceptable. If the received access credentials are acceptable, the computing device can send an instruction to the BIOS and/or operating system to grant the user access to the computing device. As used herein, electrical contact between the wearable device and computing device with the user's body can include any contact sufficient for the respective wearable device and computing device to perform the functions described herein (e.g., physical contact between the respective wearable device and computing device).

In some embodiments, in which two-part authentication is implemented, a first portion of the user's access credentials data can be received by the computing device from a wearable device and a second portion of the user's access credentials data can be received by the computing device from biometric readers configured to acquire biometric data from the user. The computing device can authenticate the acquired biometric data. Authenticating the received biometric data can include, but is not limited to, determining if the received biometric data matches biometric data stored on the computing device or implementing other, well-known methods to determine if the acquired biometric data is acceptable. If the first portion of the user's access credentials data and the second portion of the user's access credentials data (e.g., the acquired biometric data) are acceptable, the computing device can send an instruction to the BIOS and/or operating system to grant the user access to the computing device.

In embodiments in which the authentication system authenticates a user's access credentials data received from a wearable device and from biometric readers (e.g. two-part authentication), the authentication system can quickly and efficiently authenticate the user's access credentials from both sources. In some such embodiments, the computing device can be configured to acquire the access credentials data from the wearable device and from the biometric readers with a single touch of the computing device by the user. For example, in some embodiments, the biometric readers can include one or more fingerprint readers and the computing device can acquire user access credentials data from the one or more fingerprint readers and the wearable device from a single touch of the respective one or more fingers to the computing device. Furthermore, in some embodiments, the authentication system can acquire and authenticate the user's access credentials data received from the wearable device and from the biometric readers in less than about 100 milliseconds, or less than about 50 milliseconds or less than about 30 milliseconds.

The above descriptions are for purposes of illustration and are not meant to be limiting. Numerous other examples, configurations, processes, etc., may exist, some of which are described in greater detail below.

Authentication Systems

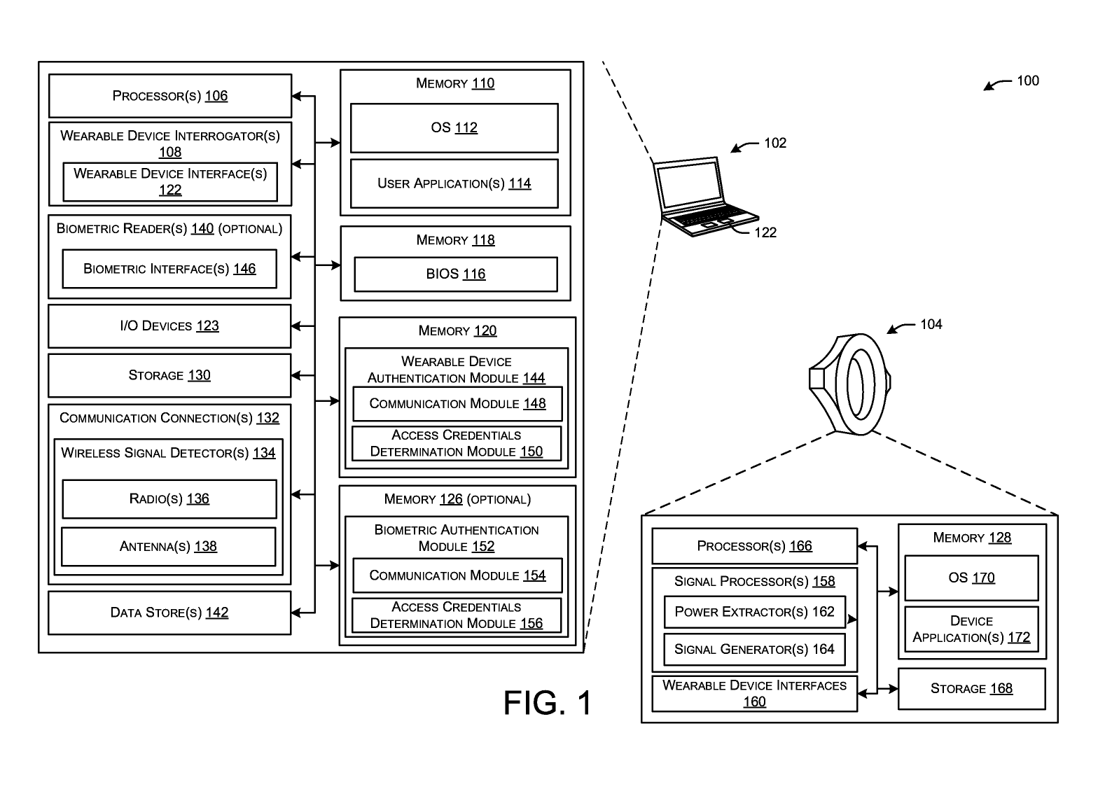

FIG. 1 is schematic representation of an example authentication system 100 for authentication access to a mobile device. The example authentication system 100 can include, but is not limited to, a computing device 102 and a wearable device 104. Examples of the computing device 102 can include, but are not limited to, an automobile, a desktop computer, a laptop computer, a mobile computing device, a mobile phone, a home or commercial security system, a tablet, etc. Examples of the wearable device 104 can include any computing device adapted to be worn on a user's body and comprising at least a processor and accessible memory. For example, the wearable device 104 can include an armband, a headband, glasses, an item of jewelry (e.g., a ring or a bracelet), a wearable chip, a wristband or an article of clothing (e.g., a shirt, pants or a hat) that includes an integrated processor and accessible memory. In some embodiments, the wearable device 104 can comprise a computing device the same as or similar to the computing device 102 that is adapted to be worn on a user's body.

As used herein, the term “device” can refer to any computing component that includes one or more processors that can be configured to execute computer-readable, computer-implemented, or computer-executable instructions. Example devices can include automobiles, a home or commercial security system, personal computers, server computers, server farms, digital assistants, smart phones (e.g., mobile phones), personal digital assistants, digital tablets, smart cards, Internet appliances, application-specific circuits, microcontrollers, minicomputers, transceivers, kiosks, or other processor-based devices. The execution of suitable computer-implemented instructions by one or more processors associated with various devices may form special purpose computers or other particular machines that may implement or facilitate authentication of access credentials data to grant a user access to a computing device.

Referring to FIG. 1, the computing device 102 can include one or more processors 106 configured to communicate with one or more memory devices and various other components or devices. For example, the computing device 102 can include one or more processors 106 and one or more wearable device interrogators 108. The processors 106 and the wearable device interrogators 108 can be implemented as appropriate in hardware, software, firmware, or a combination thereof. According to one configuration, the processors 106 may include one or more central processing units (“CPUs”) that can execute instructions associated with software in the memory 110, such as an operating system (“OS”) 112 and one or more user applications 114. The processors 106 can also execute at least a portion of the computer-executable instructions in the BIOS 116 contained in memory 118.

The wearable device interrogators 108 can execute instructions associated with software or firmware in the memory 120 to implement or facilitate authenticating access to computing device 102 using access credentials. The wearable device interrogators 108 can include one or more wearable device interfaces 122. The wearable device interfaces 122 can facilitate communication between the wearable device 104 and the wearable device interrogators 108 via the user's body. The wearable device interfaces 122 can provide a galvanic (e.g., resistive) coupling or capacitive (e.g., inductive) coupling between the user's body and the wearable device interrogators 108 when a user's body is in electrical contact with the wearable device interfaces 122.

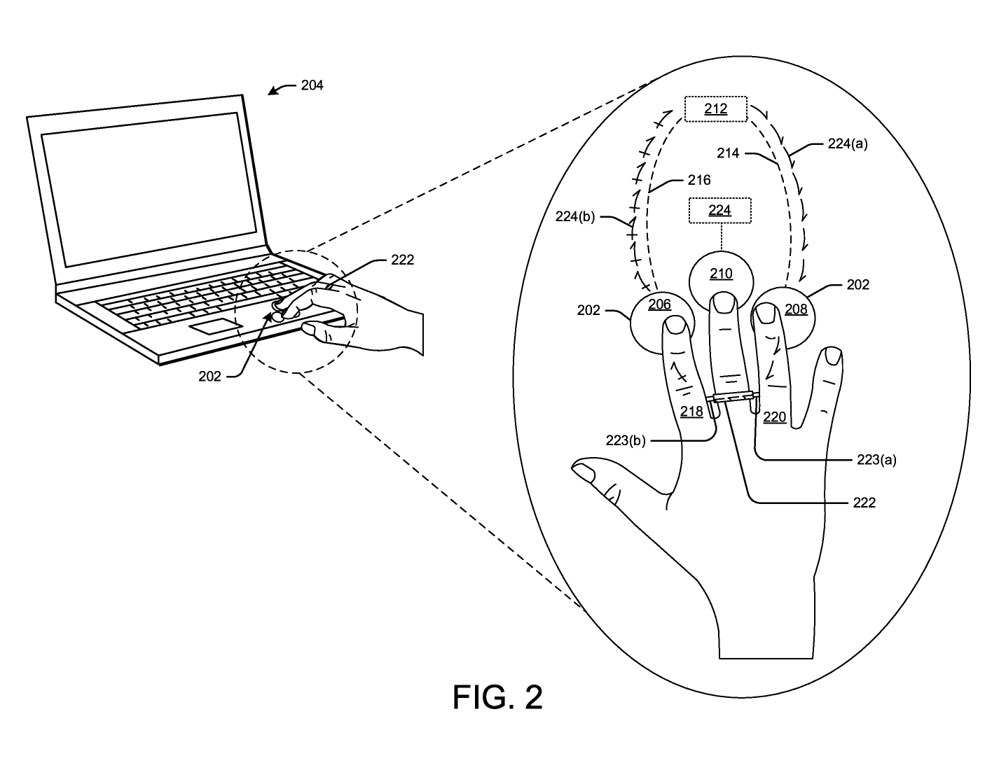

Wearable device interrogators 108 can transmit a signal to the wearable device 104 through at least a portion of the user's body in electrical contact with the wearable device interfaces 122. In such embodiments, the wearable device interrogators 108 can apply voltage (e.g., an AC voltage or a DC voltage) to the wearable device interfaces 122 to transmit a signal to the wearable device 104 when at least a portion of the user's body is in electrical contact with the wearable device interfaces 122. For example, the applied voltage can transmit the signal to the wearable device 104 by inducing an electrical current through the user's body when the user's body is in electrical contact with the wearable device interfaces 122 and the wearable device 104, as shown by way of further example in FIG. 2.

FIG. 2 is a schematic representation of an embodiment of the wearable device interfaces 202 of a computing device 204. Referring to FIG. 2, the wearable device interfaces 202 include the finger pads 206 and 208. The wearable device interrogators 212 can apply voltage to the finger pads 206 and 208 through the conductive traces 214, 216 in electrical connection with the wearable device interrogators 212 and the respective finger pads 206, 208. When the user's fingers 218 and 220 are in contact with the respective finger pads 206 and 208, the applied voltage can induce a current through the user's fingers 218 and 220 to complete an electric circuit between the wearable device interrogators 212 and the wearable device 222. The wearable device interfaces 223(a) and 223(b) of the wearable device 222 are in electrical contact with the user's fingers 220 and 218, respectively, and can facilitate directing current 224(a) to, and current 224(b) from, the components of the wearable device 222 (e.g., the wearable device 222 can create a short circuit relative to the circuit generated by the wearable device interrogators 212 through the user's body in the absence of the wearable device 222). As explained below, current 224(a) entering wearable device 220 can be modulated prior to leaving the wearable device 222. Accordingly, the current 224(a) and current 224(b) are denoted with different symbols. Additionally, as explained below, in some embodiments, the finger pad 210 can incorporate a biometric reader interface to acquire biometric data from a user. In other embodiments, the finger pad 210 can function solely as a guide to aid the user in aligning the user's body (e.g., the user's hand) to facilitate communications between the wearable device interrogators 212 and the wearable device 222.

Returning to FIG. 1, wearable device interrogators 108 can supply a voltage to the wearable device interfaces 122 via a power source (not shown) used to power computing device 102 or a power source dedicated to powering the wearable device interrogators 108. The power source can include, but is not limited to, a battery or a power source external to the computing device 102 (e.g., a wall power outlet). The amount of voltage applied to the wearable device interfaces 122 can be selected to induce a current sufficient to power the wearable device 104 to perform the functions described herein. In some embodiments, based at least in part upon the type of the wearable device (e.g. power requirements of the wearable device) and its intended location or locations on the user's body when worn, the voltage applied to the wearable device interfaces 122 can be empirically determined. In some embodiments, the voltage applied to the wearable device interfaces 122 can be selected to provide a current of at least 0.01 milliamps (“mA”); or from about 0.1 mA to about 500 mA; or from about 1 mA to about 200 mA; or from about 1 mA to about 100 mA or from about 1 mA to about 50 mA to the wearable device 104 when worn on a user's body as intended. A person of ordinary skill in the art will recognize additional current ranges within the explicitly disclosed ranges are contemplated by the present disclosure.

In some embodiments, the wearable device interrogators 108 can receive a signal transmitted by the wearable device 104 through the user's body when the user's body is in electrical contact with the wearable device 104 and the wearable device interfaces 122. For example, returning to FIG. 2, signal 214(b) can be transmitted from the wearable device 222, through wearable device interface 223(b) of wearable device 222, through the user's finger 218, through the finger pad 206 and through conductive trace 216 to wearable device interrogators 212. Referring again to FIG. 1, as discussed in detail below, in some embodiments, the signal transmitted by the wearable device 104 can include user access credentials data. In such embodiments, the wearable device interrogator 108 can extract the access credentials data from the transmitted signal to authenticate a user's access credentials to the computing device 102. For example, the wearable device interrogator 108 can extract a user's access credentials data from the transmitted signal by demodulating and subsequently decoding the transmitted signal to obtain the access credentials data. Wearable device interrogator 108 can send the extracted access credentials data to wearable device authentication module 144 to authenticate the access credentials data.

In some embodiments, the communication signals generated by the wearable device 104 and received by the wearable device interrogators 108 can be implemented according to a known communications protocol such as a Near field communication (“NFC”) protocol, a wireless fidelity (“WiFi”) protocol, a WiFi direct protocol, a Bluetooth protocol or a radio-frequency identification (“RFID”) protocol, which are specifically adapted for communications via signals transmitted through a user's body. In some embodiments, the wearable device interrogators 122 can include a specifically adapted NFC chip. Traditional NFC chips use communications protocols and data exchange formats based upon RFID standards including, but not limited to, for example, ISO/IEC 18092 and those defined by the NFC Forum. Traditional NFC chips include a powered induction coil to provide, wirelessly, the communications between the NFC chip and another NFC chip or tag through inductive energy transfer. In some embodiments described herein, an NFC chip can be specifically adapted to apply voltage across the wearable device interfaces 122 instead of or in addition to an induction coil to provide for non-wireless communications between the wearable device interrogators 108 and the wearable device 104. For example, an NFC chip can be specifically adapted, based on the present disclosure, to apply voltage across the wearable device interfaces 122 to generate and send signals to the wearable device 104 and also to receive and analyze signals sent from the wearable device 104 to the wearable device interrogators 108. In other embodiments, wearable device interrogators 108 can include, but are not limited to, a specifically adapted WiFi chip, a WiFi direct chip, a Bluetooth chip or an RFID chip.

Computing device 102 can also include one or more input/output (“I/O”) devices 123 that can enable a user to interact with the computing device 102 to, among other functions, utilize various software applications and/or facilitate access to the computing device 102. The I/O devices 123 can include, but are not limited to, a keyboard, a mouse, a pen, a voice input device, a touch input device, a display, a camera or an imaging device, speakers, or a printer.

In some embodiments, the computing device 102 can optionally include one or more biometric readers 140, one or more biometric interfaces 146 in electrical communication with the biometric readers 140 and optional memory 126. The optional biometric readers 140 can execute instructions associated with software or firmware in the memory 126 to implement or facilitate authentication of a user's access credentials data. In such embodiments, authentication of a user's access credentials data including biometric data received from the biometric readers 140 in conjunction with the user's access credentials data received from the wearable device 104 (via the wearable device interrogator 108) can grant the user access to the computing device 102. The one or more biometric readers 140 can include, but are not limited to, one or more fingerprint readers, one or more retinal scanners, one or more cameras (e.g., configured to capture image data of a user's face or portion thereof), one or more microphones (e.g., configured to capture audial data corresponding to the user's voice) or any combination thereof. In embodiments including fingerprint readers, the biometric interfaces 146 can provide a capacitive coupling or optical coupling (e.g., a light source configured to illuminate a fingerprint placed on the biometric interface 146 and a charge coupled device (“CCD”) to capture a digital image of the fingerprint) between the user and the biometric readers 140.

In some embodiments, the relative positioning of the biometric interfaces 146 and the wearable device interfaces 122 can be selected to facilitate acquisition of both the access credentials data received from the wearable device 104 (via the wearable device interrogator 108) and the access credentials data received by the biometric interfaces 146. In some such embodiments, the relative positioning of the wearable device interfaces 122 and the biometric interfaces 146 can be selected to reduce the number of user interactions with the computing device 102 to a single user action. For example, returning to the example embodiment schematically depicted in FIG. 2, the biometric reader 224 includes a fingerprint reader that is in communication with the biometric interface 210. The biometric interface 210 can include a capacitive fingerprint reader or an optical fingerprint reader. The relative positioning of the biometric interface 210 and the fingerpads 206 and 208 (of wearable device interfaces 202) can allow the computing device 204 to authenticate a user's access credentials with a single user action (e.g., placing the user's hand on the computing device). In some embodiments, a single user action can include a user gripping biometric interfaces 146, placing a user's palm on the biometric interfaces 146 or other methods of placing a user's body in contact with the biometric interfaces 146. Based upon the present disclosure, other relative positionings of the wearable device interfaces 122 and the biometric interfaces 146 can be selected to reduce the number of user interactions for authenticating user access credentials data acquisition, including biometric data acquisition (e.g., to a single user interaction with the computing device 102).

The computing device 102 can include numerous memories or memory devices including, but not limited to, the memories 110, 118, and 120 and can also include optional memory 126. The memories 110 and 118 can store program instructions that are loadable and executable on the processors 106, as well as data generated during the execution of these programs. The memory 120 and the memory 126 can store program instructions that are loadable and executable on the respective wearable device interrogators 108 and the optional biometric readers 140, as well as data generated during the execution of these programs. Each of the programs executed by the processors 106, the wearable device interrogator 108 and the optional biometric readers 140 is discussed in greater detail below.

Depending on the configuration and type of the computing device 102, the memories 110, 118 and 120 and the optional memory 126 can be volatile, such as random access memory (“RAM”), static random access memory (“SRAM”), dynamic random access memory (“DRAM”); or non-volatile, such as read-only memory (“ROM”), electrically erasable programmable read-only memory (“EEPROM”), flash memory, etc. According to one configuration, the memory 110 can be volatile (e.g., RAM) and the memories 118, 120 and the optional memory 126 can be non-volatile (e.g., flash memory). The memory 128 associated with at least a portion of the wearable device 104 can be the same or at least similar to one or more of the memories 110, 118, 120 or the optional memory 126, in one embodiment. The memories 110, 118, 120, 128 and the optional memory 126, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The storage 130 can include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices.

The one or more communication connections 132 can allow the computing device 102 to communicate with other devices via one or more wireless and/or wired networks (not shown). In some embodiments the wearable device 104 can include a communication connection (not shown) and the computing device 102 can communicate with the wearable device 104 to wirelessly exchange data between the two devices. In one embodiment, the communication connections 132 can include a wireless signal detector 134. The wireless signal detector 134 can include a wireless system that configures the computing device 102 to send and/or receive various types of wireless signals from other devices. Such a wireless system may include one or more radios 136 and one or more antennas 138, which may include hardware and software for sending and/or receiving wireless signals over various types of wireless networks. Such networks may include, but are not limited to, NFC, WiFi, WiFi Direct, Bluetooth, RFID, ultra-wide band (“UWB”), Zigbee, other short-range protocols, etc. In embodiments in which the wearable device 104 comprises a communication connection, the communication connections associated can be the same or at least similar to the communication connections 132. For example, the communication connections associated with the wearable device 104 can include one or more radios and antennas that can enable the wearable device 104 to receive and/or send wireless signals to the computing device 102. In some such embodiments, the wearable device 104 can include a power source (e.g., a battery) to provide power to the communication connections and/or can be powered by the signal sent by the wearable device 104.

The one or more data stores 142 may store lists, arrays, databases, flat files, etc. In some implementations, the data stores 142 may be stored in a memory external to the computing device 102 but may be accessible via one or more networks, such as with a cloud storage service. The data stores 142 can store information including access credentials data for granting access to the computing device 102, as described herein. For example, the data stores 142 can comprise one or more data structures (e.g., a database) comprising one or more user identifiers and access credentials data associated with the respective one or more users. As a further example, the data stores 142 can comprise a list of user identifiers associated with users who are authorized to access the computing device 102 and, logically associated with each user identifier, one or more passwords, one or more authorization tokens uniquely identifying a respective one or more wearable devices, biometric data (e.g., fingerprint data, retinal data, voice data, or facial image data), other access credentials used to grant a user access to the computing device 102 or any combination thereof. The stored access credentials data can be compared to the access credentials data received from the wearable device 104 (and, optionally, to access credentials data received from the biometric readers 140) to authenticate the user's access credentials and grant or deny the user access to the computing device 102.

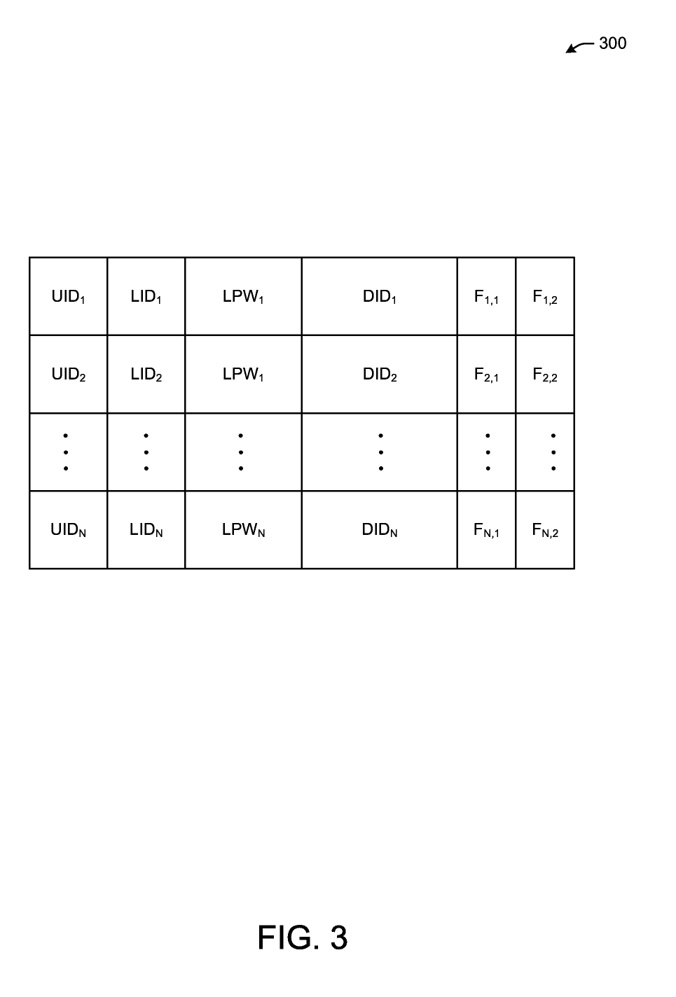

FIG. 3 is a schematic depiction of an illustrative embodiment of a data structure 300 including access credentials data. The data structure includes access credentials data for N users. For each of the N user's, access credentials data comprises a user ID (“UID”), a login ID (“LID”), a login password (“LPW”), a wearable device identifier (“DID”), a first fingerprint data (“F₁”) and a second fingerprint data (“F₂”). For example, the access credentials data logically associated with Nth user are UID_{N}, LID_{N}, LPW_{N}, DID_{N}, F_{N,1} and F_{N,2}. Although the same types of credentials are shown for each user identifier in the data structure 300, in some embodiments, each user identifier can be independently logically associated with one or more of a login ID, a login password, a wearable device identifier, a first fingerprint data or a second fingerprint data (as well as other types of biometric data). Additionally, while the data structure 300 is represented as including access credentials data, in some embodiments, a data structure can include pointers to the locations of access credentials data, to the access credentials data or a combination thereof. For example, F_{N,1} and F_{N,2} could represent pointers to the storage locations (e.g. data stores 142) where the respective fingerprint data is stored.

Turning to the contents of the memory 110, the memory 110 can include an operating system 112 (“OS”) and one or more user applications 114, among other software. As used herein, an operating system may refer to a collection of software that manages computer hardware resources and provides common services for computer programs to enable and facilitate the operation of such programs. Example operating systems may include UNIX, Microsoft Windows, Apple OS X, Android, Apple iOS etc.

The one or more user applications 114 can include various software applications that perform various functions. Such functions may rely on services provided by the operating system 112 and therefore may not be accessible until after the operating system 112 has been booted, according to certain embodiments herein. An example user application 114 can receive and store information that can facilitate validating access to the operating system 112 by a user, as described herein. According to one example, a user can utilize the user application 114 to enter a valid list of token identifiers, a valid login name, a valid password, optional valid biometric data identifiers, various other data or any combination thereof that can be used to facilitate the authentication of access credentials data.

The memory 118 can include a BIOS 116. As used herein, the BIOS 116 can refer to the initial software that is executed by a processor in a computing device (e.g., the computing device 102) when the computing device is powered on. The BIOS 116, or any other BIOS described herein, may not be an operating system to which access by a user is authenticated before the operating system is booted, as described herein. The BIOS 116 can perform various functions to implement or facilitate the processes described herein. Such processes can include, but are not limited to, loading or booting the operating system 112; communicating with the wearable device interrogators 108 and/or the biometric readers 140, to facilitate authentication of the user's access credentials to grant the user access to the computing device 102; and facilitating communication between the operating system 112 and software or firmware associated with the wearable device interrogators 108 and/or the optional biometric readers 140. Although certain embodiments herein refer to a BIOS, other suitable firmware, software, program modules, etc., that are configured to perform the same or similar processes may exist in other embodiments.

Turning to the contents of the memory 120, the memory 120 can include a wearable device authentication module 144 that can include a communication module 148 and an access credentials determination module 150. Each of these modules can be implemented as individual modules that provide specific functionality associated with granting access to a computing device by a user using access credentials data, as described herein. Alternatively, one or more of the modules may perform all or at least some of the functionality associated with the other modules.

The communication module 148 can send and/or receive various data, including but not limited to access credentials data, from the wearable device interrogators 108. The access credentials determination module 150 can communicate with the BIOS 116, the operating system 112 or both via the communications module 148 to communicate an instruction to grant access to the computing device 102. For example, the BIOS 116, the operating system 112 or both can receive instructions from the access credentials determination module 150 to grant the user access to the computing device 102. The instructions may or may not include a portion of the access credentials received from the wearable device 104, as explained below. The access credentials determination module 150 can also communicate with the wearable device interrogator 108, via the communication module 148, to receive access credentials data from the wearable device 104 (via the wearable device interrogators 108). The access credentials determination module 150 can compare access credentials data received from the wearable device 104 to valid access credentials data stored on data stores 142 (or any other suitable memory of the computing device 102) to determine whether the access credentials data received from the wearable device 104 match at least some of the stored access credentials data. Based at least in part on determining that the received access credentials data matches at least some of the stored access credentials data, the access credentials determination module 150 can send an instruction to the BIOS 116, the operating system 112 or both to grant the user access to the computing device 102.

Optionally, as described above, the computing device 102 can also include biometric readers 140 and memory 126, including a biometric authentication module 152. Each of these modules can be implemented as individual modules that provide specific functionality associated with granting access to a computing device by a user using access credentials data, as described herein. Alternatively, one or more of the modules may perform all or at least some of the functionality associated with the other modules.

The biometric authentication module 152 can include a communication module 154 and an access credentials determination module 156. For example, the BIOS 116, the operating system 112 or both can receive instructions from the access credentials determination module 156 to grant the user access to the computing device 102. The access credentials determination module 156 can also communicate with the biometric readers 140, via the communication module 154, to receive access credentials data including biometric data acquired from a user. The access credentials determination module 156 can compare access credentials received from the biometric readers 140 with valid access credentials data stored on the data stores 142 to determine whether the access credentials received from the biometric readers 140 match at least a portion of the valid access credentials data stored on the data stores 142. Based at least in part on determining that the received access credentials data matches at least some of the stored access credentials data, the access credentials determination module 156 can send an instruction to the BIOS 116, the operating system 112 or both to grant the user access to the computing device 102.

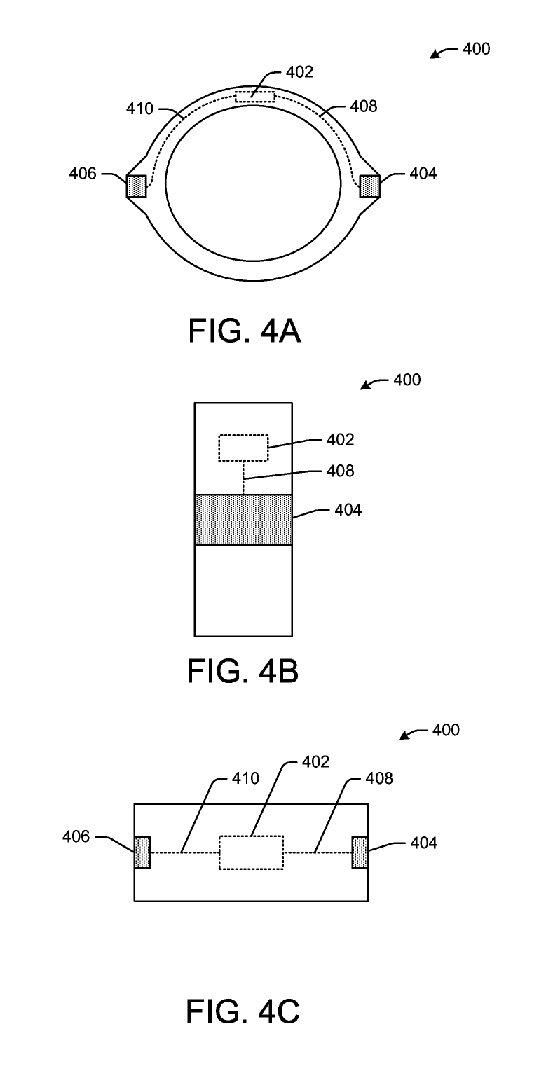

Wearable device 104 can include various hardware and software components to facilitate the processes described herein. Wearable device 104 can include one or more signal processors 158 that can execute instructions associated with software or firmware in the memory 128 to implement or facilitate authenticating access to computing device 102 using access credentials. The signal processors 158 can be in electrical communication with one or more wearable device interfaces 160. The wearable device interfaces 160 can be configured to receive a signal from a user's body, transmitted by the wearable device interrogators 108, when the wearable device interfaces 160 and 122 are in electrical contact with the user's body. The wearable device interfaces 160 can pass at least a portion of the received signal to the signal processors 158 for signal processing as described below. The wearable device interfaces 160 can also be configured to transmit a signal generated by the signal processors 158 to the wearable device interrogators 108, through the user's body, when the wearable device interfaces 160 and 122 are in electrical contact with the user's body. The wearable device interfaces 160 can provide a galvanic or capacitive coupling between the user's body and the signal processors 158. FIGS. 4(A)-4(C) are schematic representations of three orthogonal views of an embodiment of a wearable device according to the present disclosure. Referring to FIGS. 4(A)-4(C), the wearable device 400 includes the signal processors 402 and the wearable device interfaces 404 and 406. The wearable device interfaces 404 and 406 are coupled to the signal processors 402 via the respective conductive traces 408 and 410 (e.g., wires). The wearable device interfaces 404 and/or 406 can transmit signals generated by the signal processors 402 to the wearable device interrogators 108 via the user's body as described above. Wearable device interfaces 404 and/or 406 can also receive signals generated by the wearable device interrogators 108 via the user's body as described above.

Additionally, while the wearable device is represented by a ring in the figures, the representation is not intended to be limiting. As explained above, the wearable device can be any computing device including at least a processor and an accessible memory that is adapted to be worn on the user's body. Additionally, based upon the disclosure herein, a person of ordinary skill in the art will know how to send a signal from the wearable device interrogators 108 to other embodiments of the wearable device 104, and will also know how to send a signal from other embodiments of a wearable device 104 to the wearable device interrogators 108.

Returning to FIG. 1, the signal processors 158 can include a power extractor 162 and a signal generator 164. The power extractor 162 can be configured to extract power from a signal received from the wearable device interrogators 108 and deliver at least a portion of the extracted power to one or more of the hardware components of the wearable device 104 to facilitate operation of the corresponding hardware components. For example, the power extractor 162 can deliver at least a portion of the extracted power to one or more of the signal generators 164, the processors 166, the storage 168 or the memory 128 to respectively facilitate one or more of signal generation, processing functions (e.g., execution of operating system instructions and device application instructions), data retrieval and storage from the storage 168 or data retrieval and storage from the memory 128. In some embodiments, the power extractor 162 can include a rectifier and a filter to facilitate power extraction from a signal received from the wearable device interrogators 108. In some embodiments, the hardware components of the wearable device 104 can implement the functions described herein solely from the power extracted by the power extractor 162 from the signal received from the wearable device interrogators 108. In other embodiments, one or more of the hardware components of the wearable device 104 can additionally or alternatively receive power from another internal or external power source to perform their respective functions described herein. For example, in some such embodiments, one or more of the hardware components of the wearable device 104 can receive power from an internal battery (not shown) of the wearable device 104.

The signal generator 164 can generate a signal and transmit at least a portion of the generated signal to the wearable device interrogators 108 as described herein. In some embodiments, the generated signal can include access credentials data that can be used by wearable device authentication module 144 to authenticate the access credentials data, as described above. In such embodiments, the signal generator 164 can access user credentials data stored on the storage 168. The signal generator 164 can encode the credentials data and modulate the encoded credentials data onto a carrier signal. The signal generator 164 can then transmit the modulated carrier signal to the wearable device interrogator 108, via a user's body, to facilitate authentication of the user's access credentials data. In some embodiments, the carrier signal can include at least a portion of the signal received from wearable device interrogators 108. For example, returning to the exemplary embodiment depicted in FIG. 2, the signal processors (not shown) of the wearable device 222 can receive at least a portion of the signal 224(a) from the wearable device interrogator 212 via the user's finger 220. The power extractor of the signal processors can extract power from the received signal and transmit at least a portion of the extracted power to the signal generator 164 of the signal processors and storage of the wearable device 222. The signal generator 164 of the wearable device 222 can access the storage, retrieve user credentials data stored thereon, encode the user credentials data and modulate the encoded credentials data onto at least a portion of the signal 224(a) (e.g., the carrier signal). The modulated signal 224(b) can then be transmitted by the signal generator 164 to the wearable device interrogators 212 to facilitate authentication of the user's access credentials, as described above.

The wearable device 104 can include the memory 128 including an operating system (“OS”) 170 and device applications 172 installed thereon that can be executed by the processors 166. The operating system 170 can be the same or similar to the operating system 112 of the computing device 102, in one embodiment. In some embodiments, the wearable device 104 can have a BIOS (not shown) in addition to or instead of the operating system 170. In some such embodiments, the BIOS can be the same as or similar to the BIOS 116. In some embodiments, a device application of the device applications 172 can enable a transmission of a signal including access credentials data as described above. For example, in one such embodiment, the device application can monitor the state of a physical button (not shown) on the wearable device104 and can cause the signal generator 164 to transmit the signal to the wearable device interrogators 108 when the application detects that the button is pushed. In an additional or alternative embodiment, the device application can monitor the state of the power extractor 162 and, upon detecting that the power extractor 162 is extracting power from a signal received from the wearable device interrogators 108, the device application can cause the signal generator 164 to generate a signal and transmit the generated signal to the wearable device interrogators 108. Other device applications of the device applications 172 can enable the exchange of data, in addition to or instead of access credentials data, between the computing device 102 and the wearable device 104. The exchange of data can include exchanging data between the storage 130 and the data stores 142 and the storage 168. In some embodiments the data can be exchanged wirelessly, as described above.

Storage 168 can include, but is not limited to, access credentials data. The access credentials data can include, but is not limited to, an authentication token uniquely identifying the wearable device 104. The authentication token can include any series of alphabetical, numerical, or alphanumeric characters. In some embodiments, access credentials data stored in the storage 168 can be encrypted, for example, using a digital certificate as part of a public key infrastructure (“PKI”) data exchange or various other symmetric and non-symmetric encryptions techniques. In some embodiments, the wearable device 104 can also generate PKI key pairs that can be used to encrypt or decrypt information stored on the storage 168.

The above descriptions associated with FIGS. 1-3 and 4(A)-4(C) are for purposes of illustration and are not meant to be limiting. Various other examples, configurations, etc., may exist in other embodiments.

Authentication Process

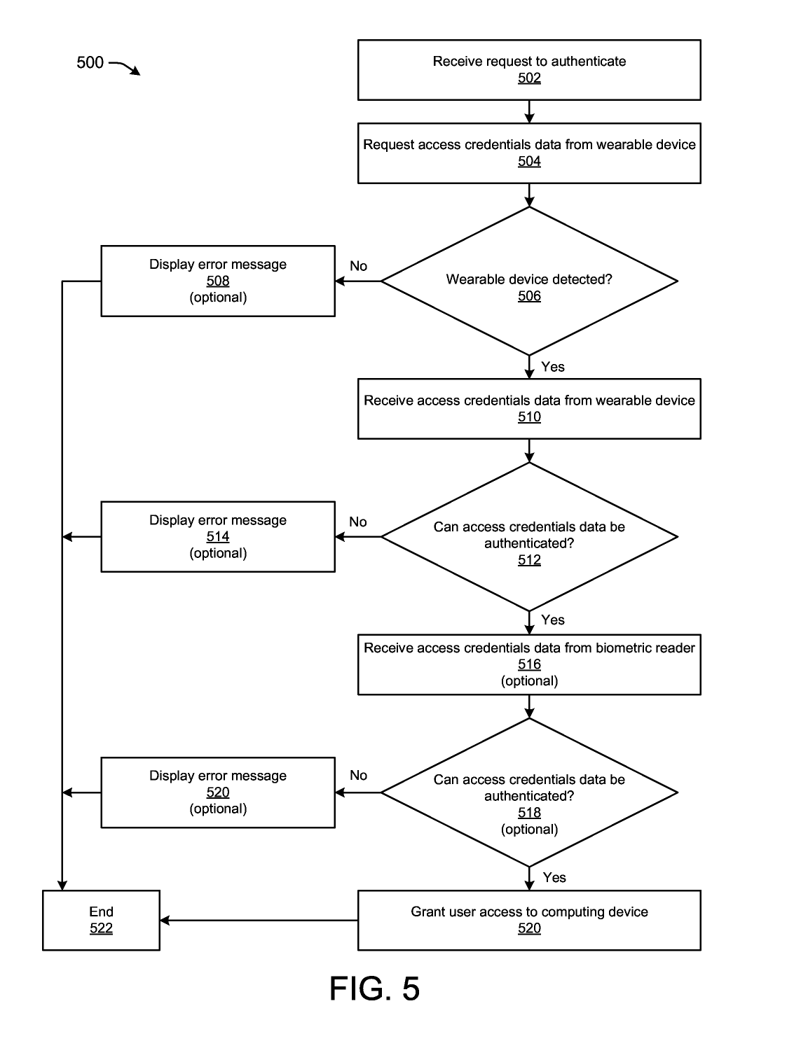

FIG. 5 depicts a flow diagram of an example process 500 for authenticating access to an operating system by a user before the operating system is booted, according to an embodiment of the disclosure. The example processes may be implemented by a computing device 102 in FIG. 1, in one embodiment.

The example processes may begin at block 502, where the OS 112 and/or the BIOS 116 receive a request to authenticate access to the computing device 102. The request can be transmitted from one or more components of the computing device 102 or the wearable device 104. With respect to transmitting the request from one or more components of the computing device 102, in some embodiments, the request can be transmitted using one or more of the I/O devices 123, optionally in conjunction with a display associated with the computing device 102 (e.g., a monitor, a screen or other display device (not shown)). For example, in some such embodiments, the request can be transmitted using a mouse and/or keyboard of the I/O devices 123. In additional or alternative embodiments, the request can be transmitted by actuating a button (not shown) of the computing device 102. In some such embodiments, one or more of the wearable device interfaces 122 and/or the biometric interfaces 146 can be configured as buttons. When the user interfaces with the one or more wearable device interfaces 122 and/or the biometric interfaces 146, the user can depress the interface to transmit the request. In additional or alternative embodiments, one or more of the wearable device interfaces 122 and/or the biometric interfaces 146 can include one or more thermal detectors (not shown), one or more optical detectors (not shown), one or more touch sensors (not shown) or one or more proximity sensors (e.g., ultrasonic proximity sensors or radar proximity sensors) (not shown), to detect the presence of the user's body in contact with the one or more of the wearable device interfaces 122 and/or the biometric interfaces 146. In such embodiments, the request can be transmitted when the detector detects the presence of the user's body in contact with the one or more of the wearable device interfaces 122 and/or the biometric interfaces 146. Embodiments having one or more of the wearable device interfaces 122 and/or the biometric interfaces 146 can be desirable because they reduce the number of user actions performed for authentication.

With respect to transmitting the request from the wearable device 104, the request can be transmitted from a button of the wearable device 104 as described above. In additional or alternative embodiments, also as discussed above, the signal can be transmitted from the OS 170 and/or the device applications 172 upon detecting power generation from the power extractor 160. In some such embodiments, the wearable device interrogators 108 can apply voltage to one or more of the wearable device interfaces 122 continuously or for preselected time intervals with a preselected time spacing between intervals. The process then continues to block 504.

At block 504, one or more of the OS 112 and/or the BIOS 116 can send an instruction to the wearable device interrogator 108 to request access credentials data from the wearable device 104. In some embodiments, the instruction can include an instruction to the wearable device interrogator 108 to apply a voltage to one or more of the wearable device interfaces 122. As explained above, the voltage can be applied by the wearable device interrogator 108 to the wearable device interfaces 122 to send a signal to the wearable device 104.

At block 506, responsive to sending an instruction to the wearable device interrogator 108 at step 504, the wearable device interrogators 108 can determine whether wearable device 104 is detected. In some embodiments, determining whether the wearable device 104 is detected can include determining if a closed circuit is established between the wearable device interfaces 122. For example, the wearable device interrogator 108 can determine whether current is flowing in response to applying voltage to one or more of the wearable device interfaces 122 at block 504. If the wearable device 104 is not detected by the wearable device interrogators 108, the process can continue to the optional step 508, where the computing device 102 displays, to a display associated with the computing device 102, an error message to the user. In some embodiments, the error message can include a notification indicating that the wearable device 104 cannot be detected by computing device 102 and can further include one or more trouble shooting suggestions to the user. The process then continues to block 522. If the presence of the wearable device 104 is detected at block 506, the process continues to block 510.

At block 510, the wearable device interrogator 108 receives access credentials data from the wearable device 104. As explained above, in some embodiments, in response to detecting power generated by the power extractor 162, a device application of the device applications 172 can cause the signal generator 164 to send a signal including user access credentials to the wearable device interrogators 108 via a user's body. The wearable device interrogators 108 can receive the signal and extract access credentials data therefrom. The extracted access credentials data can then be passed to the access credentials determination module 150 via the communication module 148 and the process proceeds to block 512.

At block 512, the access credentials determination module 150 determines if the received access credentials data is valid. In some embodiments, as explained above, some or all of the received access credentials data can be encrypted using asymmetric or symmetric cryptographic techniques. In such embodiments, the access credentials determination module 150 decrypts the access credentials data prior to validating the received access credentials data. In some embodiments, authentication of the access credentials data includes comparing the received access credentials data to access credentials stored on the data stores 142 (or other memory of the computing device 102) and associated with users that are authorized to access the computing device 102. If the access credentials determination module 150 determines there is a match between the received access credentials data and access credentials data stored on the data stores 142, the access credentials determination module 156 can instruct the OS 112 and/or the BIOS 116 to grant the user access to the computing device 102 at block 520 (or optionally receive biometric data at block 516, as explained below). For example, in one embodiment, the received access credentials data can include an authentication token that uniquely identifies the wearable device 104 to the computing device 102. Upon receiving the authentication token, the access credentials determination module 150 can compare the received authentication token to an authentication token stored in the data stores 142 and associated with user identifiers corresponding to authorized users of the computing device 102. If the access credentials determination module 150 determines that the received authentication token matches a stored authentication module, the access credentials determination module 156 can instruct the OS 112 and/or the BIOS 166 to grant the user access to the computing device 102 at block 520 (or optionally receive biometric data at block 516).

If, at block 512, the access credentials determination module 150 determines that the received access credentials data does not match access credentials data stored in the data stores 142, the process can optionally continue to block 514, where an error message is displayed to the user (the process continues to block 522 if optional block 514 is not implemented). The error message can notify the user that the access credentials received by the wearable device interrogator 108 do not correspond to an authorized user of the computing device 102 and/or that access to the computing device 102 is denied to the user. The process then continues to block 522. If, at block 512, the access credentials determination module 150 determines that the received access credentials data matches the access credentials data stored in the data stores 142, the process optionally continues to block 516 (the process continues to block 520 if optional block 518 is not implemented).

At block 516, the biometric readers 140 receive access credentials data including biometric data obtained from the user. In some embodiments, the biometric data can include fingerprint data, retinal data, voice data, facial image data or any combination thereof, as explained above. The biometric readers 140 can send the received biometric data to the access credentials determination module 156 via the communications module 154. For example, in one embodiment, the biometric readers 140 can acquire fingerprint data from one or more of the user's fingers. The acquired fingerprint data can then be sent to the access credentials determination module 156 for authentication at block 518.

In some embodiments in which block 516 is implemented, the OS 112 and/or the BIOS 116 can send an instruction to the wearable device interrogators 108 to turn off power to the wearable device interrogators 108 while the biometric readers 140 are capturing biometric data from the user. For example, where the biometric interfaces 146 include a capacitive coupling between the user's body and the biometric readers 140, the biometric interfaces 146 can be susceptible to interference from the current induced through the user's body by the wearable device interrogators 108 and/or electric fields generated by the wearable device interrogators 108. In such embodiments, it can be desirable to turn off power to the wearable device interrogators 108 to help reduce interference while capturing biometric data.

At block 518, the access credentials determination module 156 determines if the received access credentials data is valid. In some embodiments, authentication of access credentials data includes comparing the received access credentials data to access credentials stored on the data stores 142 (or other memory of the computing device 102) and associated with users that are authorized to access the computing device 102. If the access credentials determination module 150 determines there is a match between the received access credentials data and access credentials data stored on the data stores 142, the access credentials determination module 156 can instruct the OS 112 and/or the BIOS 116 to grant the user access to the computing device 102 at block 520. For example, in one embodiment, the received access credentials data can include fingerprint data obtained from one or more of the user's fingers. Upon receiving the fingerprint data, the access credentials determination module 150 can compare the received fingerprint data to fingerprint data stored in the data stores 142 and associated with user identifiers corresponding to authorized users of the computing device 102. If the access credentials determination module 150 determines that the received fingerprint data matches a stored authentication module, the access credentials determination module 156 can instruct the OS 112 and/or the BIOS 116 to grant the user access to the computing device 102 at block 520.

If, at block 518, the access credentials determination module 156 determines that the received access credentials data does not match access credentials data stored in the data stores 142, the process can optionally continue to block 520 where an error message is displayed to the user (the process continues to block 522 if optional block 520 is not implemented). The error message can inform the user that the access credentials received by the biometric readers 140 do not correspond to an authorized user of the computing device 102 and/or that access to the computing device 102 is denied to the user. The process then continues to block 522. If, at block 518, the access credentials determination module 156 determines that the received access credentials data matches access credentials data stored in the data stores 142, the process optionally continues to block 520.

At block 520, if block 518 is not implemented, the access credentials determination module 150 transmits instructions to grant the user access to the computing device 102. If block 518 is implemented, the access credentials determination module 156 transmits instructions to the OS 112 and/or the BIOS166 to grant the user access to the computing device 102. In some embodiments, the instructions can include at least a portion of the access credentials data received from the wearable device interrogators 108 and/or the biometric readers 140. In some embodiments, the instructions can include access credentials data requested by the OS 112 and/or the BIOS 116 that were not received at block 512 (and optionally not received at block 518). In some such embodiments, the wearable device authentication module 144 (and/or optionally the biometric authentication module 152) can look-up access credentials expected by the OS 112 and/or the BIOS 116 for login and include those access credentials in the respective instructions to OS 112 and/or BIOS 116. For example, with reference to FIG. 3, if the OS 112 expects a login ID and a login password to grant access to the computing device 102, and an authentication token DID₂ is received at block 510, the wearable device authentication module 144 can access the data stores 142 and identify LID₂ and LPW₂ as the respective login ID and login password of user UID₂ logically associated with authentication token DID₂. The wearable device authentication module 146 can then send LID₂ and LPW₂ to the OS 112 to grant the user access to the computing device 102. The process then ends at block 522.

While example process 500 references blocks in a particular order, a person of ordinary skill in the art will recognize other process block orders can be readily implemented based on the present disclosure and are contemplated herein. For example, in some embodiments, the process block related to access credentials received from the wearable device 104 can be performed after process block related to access credentials received from the biometric readers 140. In one such example, the process blocks 504-514 can be performed after the process blocks 516-520. As another example, in some embodiments, access credentials data can be received from the wearable device 104 and the biometric readers 140 prior to authenticating the respective access credentials data. In one such example embodiment, the process blocks 510 and 516 can be performed prior to block 512.

While the embodiments above generally relate to authentication of a user's access credentials data, in other embodiments, the computing device 102 and the wearable device 104 can exchange data files. For example, the computing device 102 and the wearable device 104 can exchange data files including, but not limited to, audio data files, video data files, document data files (e.g., Microsoft® Word, Excel and Power Point data files, Adobe® Acrobat data files), text data files and/or file system data (e.g., a listing of data files stored on the respective devices). Referring to FIG. 1, in embodiments in which the computing device 102 transmits data files to the wearable device 104, the computing device 102 can further include a signal generator (not shown) the same as or similar to signal generator 164 that can access data files and modulate them onto a carrier signal. The data files can be stored in storage 130, data stores 142, memory 110 or any other suitable memory accessible to the signal generator. The modulated signal can then be transmitted through a user's body to the wearable device 104, as similarly shown in the example embodiment schematically depicted in FIG. 2. The wearable device 014 can include a demodulator (not shown) to extract the data files from the carrier signal and store the extracted data files in the memory 128, the storage 168 or any other storage accessible to the demodulator of the wearable device 104. In embodiments in which the wearable device 104 transmits data files to the computing device 102, data files can be stored memory 128, storage 168 or any other suitable memory accessible to the signal generator 164 of the signal processors 158. As described above, the signal processors 158 can modulate the data files onto a carrier signal and transmit the modulated carrier signal through a user's body to the computing device. Also as described above, the authentication module 144, or a same or similar module (not shown) can demodulate the signal and extract the data files from the modulated signal. The computing device 102 can store the extracted data files on storage 130, data stores 142, memory 110 or any other memory accessible to the authentication module 144 (or a same or similar module).

In some embodiments, the OS 112 or user applications 114 can facilitate the exchange of data files between the computing device 102 and the wearable device 104. For example, in some embodiments, when a user's body is in contact with the computing device 102, the OS 112 or a user application 114 of computing device 102 can request file system data from the wearable device 104 and can display the received data from the wearable device 104. The user can select one or more data files the user wishes to transfer to the computing device 102 and the OS 112 or a user application 114 can facilitate the transfer of the selected data files to the computing device 102, as described above. In some embodiments, the OS 112 or a user application 114 can display a list of data files stored on storage 130, data stores 142 or memory 110 (or any other suitable memory accessible to the OS 112 or the user application 114). A user can select one or more data files to the user wishes to transfer to the wearable device 102 and the OS 112 or a user application 114 can facilitate the transfer of the selected data files to the computing device 102, as described above. In some such embodiments, the OS 112 can provide contextual menus (e.g., pop-up menus displayed when a user interacts with an icon representing a data file) including a selectable option to transfer a data file to the wearable device 104 or from the wearable device 104.

In some embodiments, the OS 112 or user application 114 can use data files and/or authentication data (e.g., access credentials data, optionally including biometric data) stored on the wearable device 104 to facilitate a wide range of other functionalities. For example, in some embodiments, an application 114 can use authentication data stored on the wearable device 104 to authenticate herself to a website. In some such embodiments, the user application 114 can include a web browser. The user can access a website using the web browser and, if the website requests authentication data for login (or for access to specific functionalities of the website), the user can place her body in contact with the computing device 102 and the user application 114 can receive the authentication data stored on the wearable device 104, as described above. The user application 114 can transmit the received authentication data to the website and the website can authenticate the authentication data to login the user (or to grant the user access to specific functionalities of the website). As an additional example, in some embodiments, a user application 114 can facilitate encryption and/or decryption of files on any suitable memory accessible to the processors 106 (e.g., storage 130, data stores 142, memory 110, memory 118, memory 120 and memory 126). In some such embodiments, the memory 128 and/or storage 168 can have an encryption key (e.g., secret key, public key, private key, digital certificate) stored thereon. The user can place her body in contact with the computing device 102 and the user application 114 can retrieve the stored key and use the retrieved key to encrypt and/or decrypt data files on a storage associated with the computing device 102, as described above.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks.

As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

### Further Embodiments

According to a first example embodiment, there is disclosed a wearable device including a memory having computer instructions and access credentials data stored thereon and a processor configured to access the memory and execute the computer instructions. The processor executes the computer instructions to receive, via a first interface in contact with a first portion of a user's body, a signal from a wearable device interrogator of a computing device and generates, based at least in part on the first signal, a second signal carrying the access credentials data. The processor can also execute the computer instructions to additionally transmit, via a second interface in contact with a second portion of the user's body, the second signal to the wearable device interrogator for authentication of the access credentials data.

In an example embodiment, the first portion of the user's body can be the same as or different from the second portion of the user's body. In an additional or alternative example embodiment, the wearable device includes an armband, a headband, an item of jewelry, a wearable chip, a wristband or an article of clothing. In such additional or alternative example embodiments, the wearable device can includes a ring and the first interface can be configured to contact the skin tissue of a first finger and the second interface can be configured to contact the skin tissue of a second finger when the ring is worn on a third finger. In some embodiments, the first interface and second interface independently include a galvanic coupling or a capacitive coupling. In some embodiments, to generate the second signal, the processor executes further computer instructions to modulate the access credentials data onto at least a portion of the first signal using amplitude modulation. In some embodiments, the wearable device includes a power extractor configured to extract power from the first signal and provide at least a portion of the extracted power to at least one of (i) a signal generator to generate the second signal, (ii) the processor or (iii) the memory.

According to a second example embodiment, there is disclosed a computing device including a memory having computer instructions and an authentication token stored thereon and a processor configured to access the memory and execute the computer instructions. The processor can execute the computer instructions to generate a first signal and transmit, via a first interface in contact with a first portion of a user's body, the first signal to a wearable device. The processor can also execute the computer instructions to receive, via a second interface in contact with a second portion of the user's body, a second signal from the wearable device and extract, responsive to transmitting the first signal, access credentials data from the first signal. Additionally, the process can also execute the computer instruction to authenticate the access credentials data.

In an example embodiment the first signal can supply power to the wearable device. In an additional or alternative embodiment, to extract the access credentials data, the processor is configured to execute further computer instructions to demodulate the second signal using amplitude demodulation. In some embodiments, to authenticate the extracted access credentials data, the processor is configured to execute further computer instructions to determine whether at least a portion of the extracted access credentials data matches stored access credentials data logically associated with an authorized user of the computing device; grant the user access to the computing device, if the at least a portion of the access credentials data matches the stored access credentials logically associated with an authorized user or deny the user access to the computing device, if the at least a portion of the access credentials data does not match the stored access credentials logically associated with an authorized user.

In an additional or alternative embodiment, the processor is configured to execute further computer instructions to capture, via a biometric reader of the computing device, biometric data from the user and authenticate the biometric data. In some embodiments, the biometric data includes fingerprint data. In some embodiments, to capture the biometric data, the processor is configured to execute further computer instructions to capture, via the biometric reader, the fingerprint data from the user's finger.

In one embodiment, to authenticate the extracted access credentials data, the processor is configured to execute further computer instructions to determine whether at least a portion of the extracted access credentials data matches stored access credentials data logically associated with an authorized user of the computing device. In such an embodiment, to authenticate the captured biometric data, the processor is configured to execute further computer instructions to determine whether at least a portion of the captured biometric data matches stored biometric data logically associated with the authorized user of the computing device. In some embodiments, the processor is configured to execute further computer instructions to grant the user access to the computing device, if the at least a portion of the extracted access credentials data matches the stored access credentials logically associated with the authorized user and the at least a portion of the captured biometric data matches the stored biometric data logically associated with the authorized user or deny the user access to the computing device, if the at least a portion of the extracted access credentials data does not match the stored access credentials logically associated with an authorized user or the at least a portion of the captured biometric data does not match the stored biometric data logically associated with the authorized user.

According to a third example embodiment, there is disclosed a method executed by a wearable device including a processor and an accessible memory. The method can include receiving, via a first interface in contact with a first portion of a user's body, a signal from a wearable device interrogator of a computing device and generating, based at least in part on the first signal, a second signal carrying at least a portion of the access credentials data. In some embodiments, the method can further include transmitting, via a second interface in contact with a second portion of the user's body, the second signal to the wearable device interrogator for authentication of the access credentials data.

In some embodiments, the first portion of the user's body can be the same as or different from the second portion of the user's body. In some embodiments, the wearable device includes an armband, a headband, an item of jewelry, a wearable chip, a wristband or an article of clothing. In additional or alternative embodiments, the wearable device includes a ring, and the first interface is configured to contact the skin tissue of a first finger, and the second interface is configured to contact the skin tissue of a second finger when the ring is worn on a third finger. In some embodiments, the first interface and the second interface independently include a galvanic coupling or a capacitive coupling. In some embodiments, the generating a second signal includes modulating the at least a portion of the access credentials data onto at least a portion of the first signal using amplitude modulation. In additional or alternative embodiments, the method can further include extracting, via a power extractor, power from the first signal, and the generating the second signal can include generating, based at least in part on at least a portion of the extracted power, the second signal.

According to a fourth example embodiment, there is disclosed a method executed by a computing device including a processor and an accessible memory. The method can include generating, by the computing device, a first signal and transmitting, by the computing device via a first interface in contact with a first portion of a user's body, the first signal to a wearable device. In some embodiments, the method can further include receiving, by the computing device via a second interface in contact with a second portion of the user's body, a second signal from the wearable device and extracting, by the computing device and responsive to transmitting the first signal, access credentials data from the first signal. In some embodiments, the method can still further include authenticating, by the computing device, the extracted access credentials data.

In some embodiments the first signal supplies power to the wearable device. In some embodiments, the extracting the access credentials data includes demodulating the second signal using amplitude demodulation. In additional or alternative embodiments the authenticating the extracted access credentials data includes determining whether the at least a portion of the extracted access credentials data matches stored access credentials data logically associated with an authorized user of the computing device and granting the user access to the computing device, if the at least a portion of the extracted access credentials data matches the stored access credentials logically associated with an authorized user or denying the user access to the computing device, if the at least a portion of the extracted access credentials data does not match the stored access credentials logically associated with an authorized user.

In some embodiments, the method further includes capturing, by the computing device via a biometric reader, biometric data from the user and authenticating, by the computing device, the biometric data. In some such embodiments, the biometric data includes finger print data and the capturing includes capturing the fingerprint data from the user's finger. In some embodiments, the authenticating the extracted access credentials data includes determining whether the at least a portion of the extracted access credentials data matches stored access credentials data logically associated with an authorized user of the computing device and the authenticating the acquired biometric data includes determining whether the at least a portion of the acquired biometric data matches stored biometric data logically associated with the authorized user of the computing device. In such embodiments, the method can further include granting, by the computing device, the user access to the computing device, if the at least a portion of the extracted access credentials data matches the stored access credentials logically associated with the authorized user and the at least a portion of the captured biometric data matches the stored biometric data logically associated with the authorized user or denying, by the computing device, the user access to the computing device, if the at least a portion of the extracted access credentials data does not match the stored access credentials logically associated with an authorized user or the at least a portion of the captured biometric data does not match the stored biometric data logically associated with the authorized user.

According to a fifth example embodiment, there is disclosed one or more computer-readable media storing computer-executable instructions that, when executed by at least one processor, configure the at least one processor to perform operations. The operations can include receiving, via a first interface in contact with a first portion of a user's body, a signal from a wearable device interrogator of a computing device and generating, based at least in part on the first signal, a second signal carrying at least a portion of the access credentials data. The operations can further include transmitting, via a second interface in contact with a second portion of the user's body, the second signal to the wearable device interrogator for authentication of the access credentials.

In some embodiments, the first portion of the user's body can be the same as or different from the second portion of the user's body. In some embodiments, the wearable device includes an armband, a headband, an item of jewelry, a wearable chip, a wristband or an article of clothing. In some such embodiments, the wearable device can include a ring where the first interface is configured to contact the skin tissue of a first finger, and the second interface is configured to contact the skin tissue of a second finger when the ring is worn on a third finger. In some embodiments, the first interface and the second interface can independently include a galvanic coupling or a capacitive coupling. In additional or alternative embodiments, the generating the second signal can include modulating the at least a portion of the access credentials data onto at least a portion of the first signal using amplitude modulation. In some embodiments, the operations can further include extracting power from the first signal and providing at least a portion of the extracted power to at least one of (i) a signal generator to generate the second signal, (ii) the processor or (iii) the memory of a wearable device.

According to a sixth example embodiment, there is disclosed one or more computer-readable media storing computer-executable instructions that, when executed by at least one processor, configure the at least one processor to perform operations. The operations can include generating a first signal and transmitting, via a first interface in contact with a first portion of a user's body, the first signal to a wearable device. The operations can further include receiving, via a second interface in contact with a second portion of the user's body, a second signal from the wearable device and extracting, responsive to transmitting the first signal, access credentials data from the first signal. The operations can also include authenticating the extracted access credentials data.

In some embodiments, the first signal supplies power to the wearable device. In some embodiments, the extracting the access credentials data includes demodulating the second signal using amplitude demodulation. In additional or alternative embodiments, the authenticating the at least a portion of the extracted access credentials data includes determining whether the extracted access credentials data matches stored access credentials data logically associated with an authorized user of the computing device and granting the user access to the computing device, if the at least a portion of the extracted access credentials data matches the stored access credentials logically associated with an authorized user or denying the user access to the computing device, if the at least a portion of the extracted access credentials data does not match the stored access credentials logically associated with an authorized user.

In some embodiments, the operations can further include capturing, via a biometric reader, biometric data from the user and authenticating the biometric data. In some such embodiments, the biometric data includes fingerprint data and wherein the capturing includes capturing the fingerprint data from the user's finger. In some embodiments, the authenticating the extracted access credentials data includes determining whether at least a portion of the extracted access credentials data matches stored access credentials data logically associated with an authorized user of the computing device, and the captured biometric data includes determining whether the at least a portion of the captured biometric data matches stored biometric data logically associated with the authorized user of the computing device. In some such embodiments, further operations can include granting, by the computing device, the user access to the computing device, if the at least a portion of the extracted access credentials data matches the stored access credentials logically associated with the authorized user and the at least a portion of the captured biometric data matches the stored biometric data logically associated with the authorized user or denying, by the computing device, the user access to the computing device, if the at least a portion of the extracted access credentials data does not match the stored access credentials logically associated with an authorized user or the at least a portion of the captured biometric data does not match the stored biometric data logically associated with the authorized user.

In a seventh example embodiment, there is described a wearable device including a memory having computer instructions and access credentials data stored thereon and a processor configured to access the memory and execute the computer instructions. The wearable device can also include a means for receiving a signal transmitted through a user's body by a computing device and a means for generating, based at least in part on the first signal, a second signal carrying the access credentials data. In some embodiments, the wearable device can also include a means for transmitting, via a second interface in contact with a second portion of the user's body, the second signal to a computing device for authentication of the access credentials data.

In some embodiments, the first portion of the user's body is the same as or different from the second portion of the user's body. In some embodiments, the wearable device includes an armband, a headband, an item of jewelry, a wearable chip, a wristband or an article of clothing. In some such embodiments, the wearable device includes a ring and the means for receiving a signal is configured to contact the skin tissue of a first finger the skin tissue of a second finger when the ring is worn on a third finger. In some embodiments, the means for receiving a signal includes a galvanic coupling or a capacitive coupling. In some embodiments,

the means for generating a signal modulates the access credentials data onto at least a portion of the first signal using amplitude modulation. In some embodiments, the wearable device further includes a means for extracting power from the first signal and a means for providing at least a portion of the extracted power to at least one of (i) a signal generator to generate the second signal, (ii) the processor or (iii) the memory.

In an eighth example embodiment, there is disclosed a computing device including a memory having computer instructions and an authentication token stored thereon and a processor configured to access the memory and execute the computer instructions. The computing device can also include a means for generating a first signal and a means for transmitting, via a first portion of a user's body, the first signal to a wearable device. In some embodiments, the computing device can also include a means for receiving, via a second portion of the user's body, a second signal from the wearable device and a means for extracting, responsive to transmitting the first signal, access credentials data from the first signal. In additional or alternative embodiments, the computing device can also include a means for authenticating the access credentials data.

In some embodiments the first signal supplies power to a power extracting means of the wearable device. In additional or alternative embodiments the means for extracting demodulates the second signal using amplitude demodulation. In some embodiments, the means for authenticating includes a means for determining whether at least a portion of the extracted access credentials data matches stored access credentials data logically associated with an authorized user of the computing device and a means for granting the user access to the computing device, if the at least a portion of the access credentials data matches the stored access credentials logically associated with an authorized user or a means for denying the user access to the computing device, if the at least a portion of the access credentials data does not match the stored access credentials logically associated with an authorized user.

In additional or alternative embodiments, the computing device further includes a means for capturing, via a biometric reader of the computing device, biometric data from the user and a means for authenticating the biometric data. In some such embodiments, the biometric data includes finger print data and the means for capturing includes a means for capturing the fingerprint data from the user's finger.

In additional or alternative embodiments, the means for authenticating the extracted access credentials data includes a means for determining whether at least a portion of the extracted access credentials data matches stored access credentials data logically associated with an authorized user of the computing device and the means for authenticating the captured biometric data includes a means for determining whether at least a portion of the captured biometric data matches stored biometric data logically associated with the authorized user of the computing device. In such embodiments, the computing device further includes a means for granting the user access to the computing device, if the at least a portion of the extracted access credentials data matches the stored access credentials logically associated with the authorized user and the at least a portion of the captured biometric data matches the stored biometric data logically associated with the authorized user or a means for denying the user access to the computing device, if the at least a portion of the extracted access credentials data does not match the stored access credentials logically associated with an authorized user or the at least a portion of the captured biometric data does not match the stored biometric data logically associated with the authorized user.

What is claimed is:

1. A wearable device comprising:
a memory having computer instructions and access credentials data stored thereon;
a processor configured to access the memory and execute the computer instructions to:
receive, via a first interface in contact with a first portion of a user's body, a signal from a wearable device interrogator of a computing device;
generate, based at least in part on the first signal, a second signal carrying the access credentials data; and
transmit, via a second interface in contact with a second portion of the user's body, the second signal to the wearable device interrogator for authentication of the access credentials data.

2. The wearable device of claim 1, wherein the first portion of the user's body is the same as or different from the second portion of the user's body.

3. The wearable device of claim 1, wherein the wearable device comprises an armband, a headband, an item of jewelry, a wearable chip, a wristband or an article of clothing.

4. The wearable device of claim 3,
wherein the wearable device comprises a ring and
wherein the first interface is configured to contact the skin tissue of a first finger and the second interface is configured to contact the skin tissue of a second finger when the ring is worn on a third finger.

5. The wearable device of claim 1, wherein the first interface and the second interface independently include a galvanic coupling or a capacitive coupling.

6. The wearable device of claim 1, wherein to generate the second signal, the processor executes further computer instructions to: modulate the access credentials data onto at least a portion of the first signal using amplitude modulation.

7. The wearable device of claim 1, further comprising:
a power extractor configured to extract power from the first signal and provide at least a portion of the extracted power to at least one of (i) a signal generator to generate the second signal, (ii) the processor or (iii) the memory.

8. A computing device comprising:
a memory having computer instructions and an authentication token stored thereon;
a processor configured to access the memory and execute the computer instructions to:
generate a first signal;
transmit, via a first interface in contact with a first portion of a user's body, the first signal to a wearable device;
receive, via a second interface in contact with a second portion of the user's body, a second signal from the wearable device;
extract, responsive to transmitting the first signal, access credentials data from the first signal; and
authenticate the access credentials data.

9. The computing device of claim 8, wherein the first signal supplies power to the wearable device.

10. The computing device of claim 8, wherein to extract the access credentials data, the processor is configured to execute further computer instructions to: demodulate the second signal using amplitude demodulation.

11. The computing device of claim 8, wherein to authenticate the extracted access credentials data, the processor is configured to execute further computer instructions to:
determine whether at least a portion of the extracted access credentials data matches stored access credentials data logically associated with an authorized user of the computing device;
grant the user access to the computing device, if the at least a portion of the access credentials data matches the stored access credentials logically associated with an authorized user; or
deny the user access to the computing device, if the at least a portion of the access credentials data does not match the stored access credentials logically associated with an authorized user.

12. The computing device of claim 8, wherein the processor is configured to execute further computer instructions to:
capture, via a biometric reader of the computing device, biometric data from the user; and
authenticate the biometric data.

13. The computing device of claim 12, wherein the biometric data comprises finger print data and wherein to capture the biometric data the processor is configured to execute further computer instructions to: capture, via the biometric reader, the fingerprint data from the user's finger.

14. The computing device of claim 12,
wherein to authenticate the extracted access credentials data, the processor is configured to execute further computer instructions to: determine whether at least a portion of the extracted access credentials data matches stored access credentials data logically associated with an authorized user of the computing device;
wherein to authenticate the captured biometric data, the processor is configured to execute further computer instructions to: determine whether at least a portion of the captured biometric data matches stored biometric data logically associated with the authorized user of the computing device; and
wherein the processor is configured to execute further computer instructions to:
grant the user access to the computing device, if the at least a portion of the extracted access credentials data matches the stored access credentials logically associated with the authorized user and the at least a portion of the captured biometric data matches the stored biometric data logically associated with the authorized user; or
deny the user access to the computing device, if the at least a portion of the extracted access credentials data does not match the stored access credentials logically associated with the authorized user, or the at least a portion of the captured biometric data does not match the stored biometric data logically associated with the authorized user.

15. A method executed by a wearable device comprising a processor and an accessible memory, the method comprising:
receiving, via a first interface in contact with a first portion of a user's body, a signal from a wearable device interrogator of a computing device;
generating, based at least in part on the first signal, a second signal carrying at least a portion of the access credentials data; and
transmitting, via a second interface in contact with a second portion of the user's body, the second signal to the wearable device interrogator for authentication of the access credentials data.

16. The method of claim 15, wherein the first portion of the user's body is the same as or different from the second portion of the user's body.

17. The method of claim 15, wherein the wearable device comprises an armband, a headband, an item of jewelry, a wearable chip, a wristband or an article of clothing.

18. The method of claim 17,
wherein the wearable device comprises a ring and
wherein the first interface is configured to contact the skin tissue of a first finger and the second interface is configured to contact the skin tissue of a second finger when the ring is worn on a third finger.

19. The method of claim 15, wherein the first interface and the second interface independently include a galvanic coupling or a capacitive coupling.

20. The method of claim 15, wherein the generating a second signal comprises modulating the at least a portion of the access credentials data onto at least a portion of the first signal using amplitude modulation.

21. The method of claim 15 further comprising:
extracting, via a power extractor, power from the first signal; and
wherein the generating the second signal comprises generating, based at least in part on at least a portion of the extracted power, the second signal.

22. A method executed by a computing device comprising a processor and accessible memory, the method comprising:
generating, by the computing device, a first signal;
transmitting, by the computing device via a first interface in contact with a first portion of a user's body, the first signal to a wearable device;
receiving, by the computing device via a second interface in contact with a second portion of the user's body, a second signal from the wearable device;
extracting, by the computing device and responsive to transmitting the first signal, access credentials data from the first signal; and
authenticating, by the computing device, the extracted access credentials data.

23. The method of claim 22, wherein the first signal supplies power to the wearable device.

24. The method of claim 22, wherein the extracting the access credentials data comprises demodulating the second signal using amplitude demodulation.

25. The method of claim 22, wherein the authenticating the extracted access credentials data comprises:
determining whether the at least a portion of the extracted access credentials data matches stored access credentials data logically associated with an authorized user of the computing device;
granting the user access to the computing device, if the at least a portion of the extracted access credentials data matches the stored access credentials logically associated with an authorized user or
denying the user access to the computing device, if the at least a portion of the extracted access credentials data does not match the stored access credentials logically associated with an authorized user.

25. The method of claim 22, wherein the method further comprises:
capturing, by the computing device via a biometric reader, biometric data from the user; and
authenticating, by the computing device, the biometric data.

26. The method of claim 25, wherein the biometric data comprises fingerprint data and wherein the capturing comprises capturing the fingerprint data from the user's finger.

27. The method of claim 22,
wherein the authenticating the extracted access credentials data comprises determining whether the at least a portion of the extracted access credentials data matches stored access credentials data logically associated with an authorized user of the computing device;
wherein the authenticating the acquired biometric data comprises determining whether the at least a portion of the acquired biometric data matches stored biometric data logically associated with the authorized user of the computing device; and
wherein the method further comprises:
granting, by the computing device, the user access to the computing device, if the at least a portion of the extracted access credentials data matches the stored access credentials logically associated with the authorized user and the at least a portion of the captured biometric data matches the stored biometric data logically associated with the authorized user; or
denying, by the computing device, the user access to the computing device, if the at least a portion of the extracted access credentials data does not match the stored access credentials logically associated with the authorized user or the at least a portion of the captured biometric data does not match the stored biometric data logically associated with the authorized user.

28. One or more computer-readable media storing computer-executable instructions that, when executed by at least one processor, configure the at least one processor to perform operations comprising:
receiving, via a first interface in contact with a first portion of a user's body, a signal from a wearable device interrogator of a computing device;
generating, based at least in part on the first signal, a second signal carrying at least a portion of the access credentials data; and
transmitting, via a second interface in contact with a second portion of the user's body, the second signal to the wearable device interrogator for authentication of the access credentials.

29. The computer-readable media of claim 28, wherein the first portion of the user's body is the same as or different from the second portion of the user's body.

30. The computer-readable media of claim 28, wherein the wearable device comprises an armband, a headband, an item of jewelry, a wearable chip, a wristband or an article of clothing.

31. The computer-readable media of claim 30,
wherein the wearable device comprises a ring; and
wherein the first interface is configured to contact the skin tissue of a first finger and the second interface is configured to contact the skin tissue of a second finger when the ring is worn on a third finger.

32. The computer-readable media of claim 28, wherein the first interface and the second interface independently include a galvanic coupling or a capacitive coupling.

33. The computer-readable media of claim 28, wherein the generating the second signal comprises modulating the at least a portion of the access credentials data onto at least a portion of the first signal using amplitude modulation.

34. The computer-readable media of claim 28, wherein the computer-executable instructions, when executed by at least one processor, configure the at least one processor to perform further operations comprising:
extracting power from the first signal and providing at least a portion of the extracted power to at least one of (i) a signal generator to generate the second signal, (ii) the processor or (iii) the memory of a wearable device.

35. One or more computer-readable media storing computer-executable instructions that, when executed by at least one processor, configure the at least one processor to perform operations comprising:
generating a first signal;
transmitting, via a first interface in contact with a first portion of a user's body, the first signal to a wearable device;
receiving, via a second interface in contact with a second portion of the user's body, a second signal from the wearable device;
extracting, responsive to transmitting the first signal, access credentials data from the first signal; and
authenticating the extracted access credentials data.

36. The one or more computer-readable media of claim 35, wherein the first signal supplies power to the wearable device.

37. The one or more computer-readable media of claim 35, wherein the extracting the access credentials data comprises demodulating the second signal using amplitude demodulation.

38. The one or more computer-readable media of claim 35, wherein the authenticating the at least a portion of the extracted access credentials data comprises:
determining whether the extracted access credentials data matches stored access credentials data logically associated with an authorized user of the computing device;
granting the user access to the computing device, if the at least a portion of the extracted access credentials data matches the stored access credentials logically associated with an authorized user; or
denying the user access to the computing device, if the at least a portion of the extracted access credentials data does not match the stored access credentials logically associated with an authorized user.

39. The one or more computer-readable media of claim 35, wherein the computer-readable media stores computer-executable instructions that, when executed by at least one processor, configure the at least one processor to perform additional operations comprising:
capturing, via a biometric reader, biometric data from the user; and
authenticating the biometric data.

40. The one or more computer-readable media of claim 39, wherein the biometric data comprises fingerprint data and wherein the capturing comprises capturing the fingerprint data from the user's finger.

41. The one or more computer-readable media of claim 35:
wherein the authenticating the extracted access credentials data comprises determining whether at least a portion of the extracted access credentials data matches stored access credentials data logically associated with an authorized user of the computing device;
wherein authenticating the captured biometric data comprises determining whether the at least a portion of the captured biometric data matches stored biometric data logically associated with the authorized user of the computing device; and
wherein the computer-readable media stores computer-executable instructions that, when executed by at least one processor, configure the at least one processor to perform additional operations comprising:
granting, by the computing device, the user access to the computing device, if the at least a portion of the extracted access credentials data matches the stored access credentials logically associated with the authorized user and the at least a portion of the captured biometric data matches the stored biometric data logically associated with the authorized user; or
deny, by the computing device, the user access to the computing device, if the at least a portion of the extracted access credentials data does not match the stored access credentials logically associated with the authorized user or the at least a portion of the captured biometric data does not match the stored biometric data logically associated with the authorized user.
